(19) United States
(12) Patent Application Publication
(10) Pub. No.: US 2025/0373112 A1
(43) Pub. Date: Dec. 4, 2025

(54) AN ELECTRICAL MACHINE

(71) Applicant: TVS MOTOR COMPANY LIMITED, Chennai (IN)

(72) Inventors: Banerjee Anaugh, Chennai (IN); Senthilnathan Sp, Chennai (IN); Prashanth Sn, Chennai (IN)

(73) Assignee: TVS MOTOR COMPANY LIMITED, Chennai (IN)

(21) Appl. No.: 18/852,014

(22) PCT Filed: Jan. 27, 2023
(86) PCT No.: PCT/IN2023/050083

§ 371 Date: Sep. 27, 2024

(30) Foreign Application Priority Data
Mar. 27, 2022 (IN) 202241017593

(51) Int. Cl. H02K 5/20; H02K 5/18; H02K 9/19; H02K 9/22

(52) U.S. Cl. CPC H02K 5/203; H02K 5/18; H02K 9/19; H02K 9/22

(57) ABSTRACT

An electrical machine includes a stator; a rotor, the rotor being electrically coupled to the stator; a first end cover, the first end cover being in thermally conductive contact with the stator at a first side of the stator; and a lid attached to the first end cover from one side of the electrical machine for enclosing a coolant within the first end cover. The first end cover includes an outer wall, the outer wall having one or more ports for receiving the coolant; an end cover annular portion, the end cover annular portion and the outer wall being spaced at a first predetermined distance ‘a’; and a base portion, the outer wall and the end cover annular portion being projecting orthogonally to the base portion thereby forming a radially enclosed passage.

### TECHNICAL FIELD

The present subject matter relates in general to an electrical machine, in particular, but not exclusively, to an electrical machine such as a motor.

### BACKGROUND

Typically, an electrical machine such as an electric motor and electrical generators are used to convert electrical energy to mechanical energy and vice-versa respectively. The electric motor produces linear or rotary force (torque) from electrical input received by it. Generally, the electric motor consists of a rotor, a stator, one or more windings and a commutator. The stator is usually the stationary part of the motor which consist of field magnets. Generally, the field magnets are either electromagnets consisting of wire windings around a ferromagnetic iron core or plurality of permanent magnets. The magnetic field created is passed through an armature of the rotor. The rotor is a moving part of the electric motor, which turns the shaft to deliver the mechanical power. The rotor usually consists of conductors that can carry currents exerted by the magnetic field of the stator thereby forcing to rotate the shaft. Alternatively, some motors carry field magnets, and the stator hold the conductors. Some motors also consist of a hall effect sensor on the stator of the motor.

### BRIEF DESCRIPTION OF THE DRAWINGS

The detailed description is described with reference to an embodiment of a motor assembly for a vehicle along with the accompanying figures. The same numbers are used throughout the drawings to reference like features and components.

FIG. 1 illustrates an exploded perspective view of an electrical machine.

FIG. 2 illustrates a perspective view of a stator of the electrical machine.

FIG. 3 illustrates a perspective view of a first end cover of the electrical machine.

FIG. 4 illustrates a perspective view of a lid of the electrical machine.

FIG. 5 illustrates a perspective view of a second end cover of the electrical machine.

### DETAILED DESCRIPTION

Typically, a large amount of heat is generated by an electric motor or a generator during conversion of the electrical energy to mechanical energy or vice-versa. Often one or more windings are used in the stator of the motor to produce magnetic field. In order to generate torque, current is forced through the motor windings which result in a steady increase of temperature in the motor windings. Further, as the temperature increases in the motor windings, the resistance of the windings also increases. The motor windings resistance (Rmt) is one of the main sources of heat generation.

In order to check the heat or temperature increase within the motor, various thermal management techniques are employed. The two most prominent thermal management techniques are air cooling of the electric motor and the liquid cooling of the electric motor. In the air cooling of the electric motor, surface fins are provided on the electric motor which dissipates the heat through natural convection or by forced convection e.g. through a fan mounted on the motor shaft. However, forced cooling mechanisms is typically not desirable in a vehicle due to layout space constraints. The challenge is further higher particularly in compact two or three wheeled vehicles which may not have the luxury of space unlike a four wheeled vehicle plus adding to a forced cooling system would undesirably increase the weight and cost of the vehicle as a whole. Such vehicles typically have a compact powertrain and thus air cooling of the electric motor is achieved through plurality of radial fins around the motor.

Another means to achieve effective cooling of electric motor is liquid cooling of electric motor. In a configuration for liquid cooling system, features such as pumps, a radiator and hoses are used. The motor heat is removed by flowing a coolant and rejected or dissipated through the radiator.

In an existing art, a plurality of ducts are provided in the stator of the motor through which coolant is passed. The coolant is passed through the frame of the stator in axial partitions. In another existing art, tangential partitions are created on the stator frame through which coolant is allowed to pass.

In another existing art, the motor housing has cooling channels which connect an external coolant supply. The rotor is provided with injection ports facing the stator and the rotor has a shaft coolant path connected to the cooling channel on the motor housing. The stator core is cooled through cooling jackets and direct inner cooling is also applied to the stator windings via fixed-point injection of the cooling jacket and the rotating injection of the magnetic isolating plates. This results in cooling of the stator windings through forced liquid cooling.

In another existing art, liquid cooling system includes a manifold extending above the stator which is receiving the liquid under pressure and having the openings that direct the liquid jets onto the stator and the end parts of the rotor. Also, trays are provided on the stator and the rotor which acquire liquid coolant from the manifold injectors and distribute gravity-fed coolant onto other parts. In such topology, the rotor and the stator are directly cooled by liquid.

In existing liquid cooling systems, the coolant actively comes in contact with the stator windings. This interaction limits the operation of stator windings. The life-span of stator windings is negatively impacted by the coolant reaching the stator. Also, when coolant reaches the stator windings, the user cannot use different varieties of coolant in the motor. In such cooling systems, only single type of coolant can be used. Any change in coolant will cause damage to the stator windings. In such cooling systems, any cleaning of cooling passage would require opening of the complete motor. Further, in case any impurity is passed through the coolant, such impurities reach the stator windings or the rotor which severely damage the operation of the motor.

Also, in other known or existing liquid cooling systems, the coolant is passed either through the frame of the motor/stator. Such cooling system require modification in motor design. Further, modification in the stator design limits the motor only to liquid cooling mechanism. Modification in the motor design on the external frame would limit the cooling of the motor only through the coolant. In such motors, air cooling system is not possible because the external surface of the motor cannot accommodate fins and liquid cooling chambers both. Also, if a provision of coolant chambers and fins is provided, the cooling would be limited as the fins for air cooling will not be sufficient. Further, in case of only liquid cooling system, the cooling of motor is limited. The coolant reaches only limited heat zones of the motor. Also, the motor with manifolds complicates the motor design and limits the cooling of the motor to liquid cooling. In design where, provision of air cooling and liquid cooling both are provided, the air-cooling fins are not utilized to their maximum potential due to design constraints. The motor frame cannot accommodate the fins as well as coolant chambers or coolant manifold.

Thus, there is a need to provide an improved cooling system of the motor which can cool majority of the heat zones of the motor while overcoming all problems stated earlier and other problems of known art. More specifically, adequate cooling is to be provided to the heat zones which produce highest heating. Further, there is a need to prevent damage to the stator windings due to the liquid coolant. Also, the motor shall be configured to accommodate diversity of coolants. Further, the motor shall be configured to fully optimizing air cooling and liquid cooling systems.

In an aspect of the present invention, an improved electrical machine is disclosed, said electrical machine comprising: a stator, a rotor, a first end cover and a lid. The rotor is coupled to the stator. The first end cover is thermally connected to the stator. The lid is enclosing the first end cover from one side of the electrical machine. The first end cover is comprising: an outer wall and an end cover annular portion. The end cover annular portion is at a first distance from the outer wall forming a radially enclosed portion. The radially enclosed portion is covered by a base surface and the base surface is in thermal connection with the stator. The radially enclosed surface receives coolant from the outer wall and the base surface is configured to prevent any leakage of the coolant.

Summary provided above explains the basic features of the present subject matter and does not limit the scope of the invention. The nature and further characteristic features of the present subject matter will be made clearer from the following descriptions made with reference to the accompanying drawings.

Exemplary embodiments detailing features of the pedal assembly, in accordance with the present subject matter will be described hereunder with reference to the accompanying drawings. Various aspects of different embodiments of the present subject matter will become discernible from the following description set out hereunder. Rather, the following description provides a convenient illustration for implementing exemplary embodiments of the present subject matter. Further, it is to be noted that terms “upper”, “lower”, “right”, “left”, “front”, “forward”, “rearward”, “downward”, “upward”, “top”, “bottom” and like terms are used herein based on the illustrated state or in a standing state of the vehicle with a rider sitting thereon unless otherwise elaborated. Furthermore, a vertical axis refers to a top to bottom axis relative to the vehicle, defining a vehicle vertical direction; while a lateral axis refers to a side to side, or left to right axis relative to said vehicle, defining a vehicle lateral direction. Further, a longitudinal axis refers to a front to rear axis relative to the vehicle, defining the vehicle in a longitudinal direction. Also, it is to be understood that the phraseology and terminology used herein is for the purpose of description and should not be regarded as limiting.

The present subject matter is further described with reference to the accompanying figures. It should be noted that description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

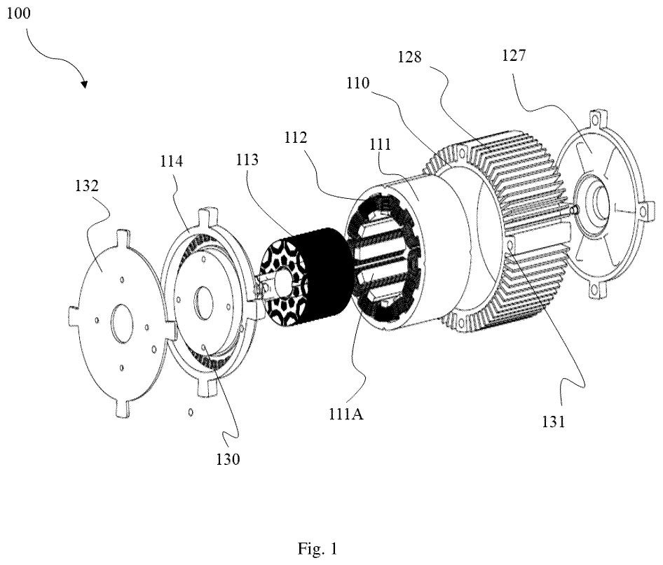

FIG. 1 illustrates an exploded perspective illustration of an electrical machine 100, As per an exemplary embodiment of the present invention. The electrical machine 100 comprises a stator 111, a rotor 113, a first end cover 114, a lid 132 and a second end cover 127. The stator 111 is a stationary part and the rotor 113 is a moving part and both are electromagnetically coupled to each other. The stator 111 is enclosed in the outer casing 110 and the first end cover 114 covers a first side of the stator 111 and the rotor 113. The first end cover 114 is locked to the outer casing 110 from one side and the second end cover 127 locks with the outer casing 110 on an opposite side of the outer casing 110. Also, the lid 132 covers the first end cover 114 by being secured to the first end cover 114 and the outer casing 110 through plurality of mounting holes (130,131).

In an embodiment, the outer casing 110 comprises one or more fins 128 on an external surface. The one or more fins 128 are configured to cool the stator 111 through an air-cooling mechanism.

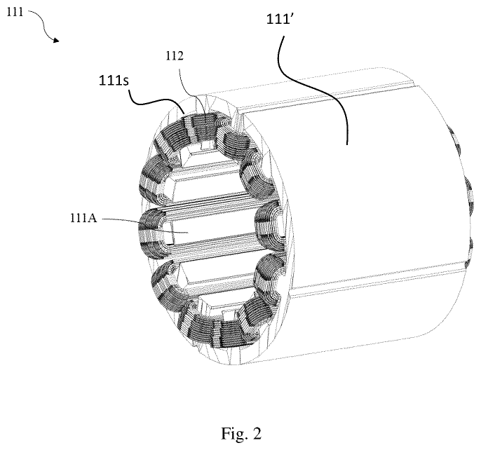

FIG. 2 illustrates a perspective view of the stator 111. The stator 111 comprising a cylindrical surface (111′) on an outer side of the stator 111 with lateral end side surfaces (111s) on each side of the cylinder. One or more stator teeth 111A are disposed on an internal cylindrical surface (not shown) of the stator 111. The teeth 111A are covered by one or more field windings 112 and on passing current through the windings the stator turns into a field magnet or electromagnet.

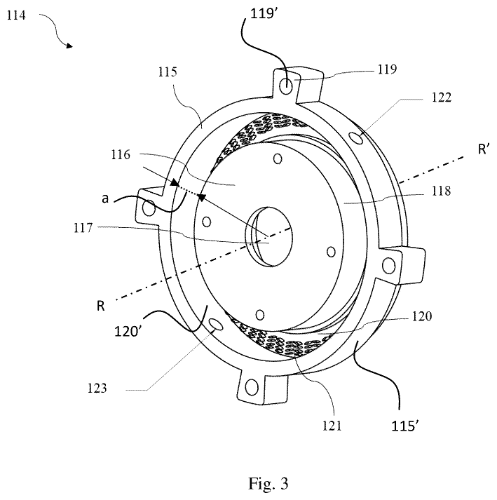

FIG. 3 illustrates a perspective view of the first end cover 114. The first end cover 114 comprises of a base portion (120), an outer annular wall 115 and an end cover inner annular portion 116 disposed concentric to the outer wall 115 with respect to a rotor axis R-R′. The outer annular wall 115 and the end cover inner annular portion 116 being projecting orthogonal to the base portion 120 and the projection being along the rotor axis R-R′ An external circumferential annular surface (115′) of the outer wall 115 is provided with one or more opening ports 122, 123 which being an inlet port 122 and an outlet port 123 for enabling flow of a cooling medium. The end cover inner annular portion 116 is spaced at a first radial distance (a) away from the outer wall 115. Further, the outer wall 115 and the end cover inner annular portion 116 and base portion 120 together form a radially enclosed passage 120′ which receives coolant from one or more ports 122, 123. The radially enclosed passage 120′ is covered by said base portion 120 and one end surface the base portion 120 is configured to be in thermal contact with the coolant while the other end surface of the base portion 120 is in thermal contact with the teeth 111A and the lateral end surface 111s of the stator 111 for transferring heat from the stator 111 to the base portion 120 through conduction.

Further, in an embodiment, the outer wall 115 comprises one or more locking portions 119 having one or more outer wall locking openings 119′ for locking the first end cover 114 to the outer casing 110.

In an embodiment, the end cover inner annular portion 116 is formed in a middle region of the first end cover 114 and having a hollow at the center of the end cover inner annular portion 116. The rotor axis R-R′ passes from the hollow at the center of the end cover inner annular portion 116. Also, the end cover inner annular portion 116 comprises a radial surface 118. The radial surface 118 forms an outer boundary of the end cover inner annular portion 116. Further, the radial surface 118 and the outer wall 115 forms the radially enclosed passage 120′ which is configured to receive cooling fluid from one or more ports 122, 123.

In another additional embodiment, the base surface 120 comprises one or more protruded portions 121. The one or more protruded portions 121 being uniformly shaped baffles. In another embodiment the one or more protruded portions 121 being non-uniformly shaped baffles where the baffles enable enhancing the conductive heat transfer to the cooling medium.

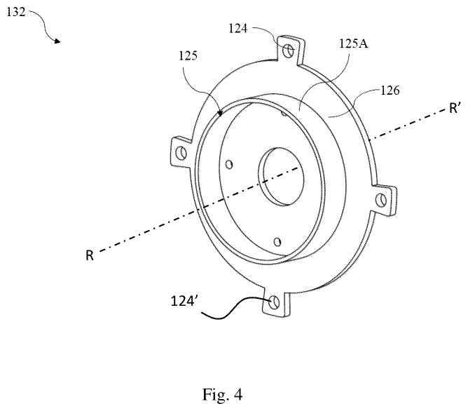

FIG. 4 illustrates a perspective view of the lid 132. The lid 132 comprises a inner planar base portion 126 and lid annular wall portion 125 projecting from the base portion 126. The lid annular portion 125 comprises a radial annular surface 125A which snugly fits on to the radial surface 118 of the end cover inner portion 116 to act as a guide for locating the lid 132. Also, the lid 132 is provided one or more lid locking portions 124 having one or more lid locking openings 124′, which align with the one or more locking portion 119 of the end cover 114 and being attached through suitable locking means for sealing the enclosed portion 120′ between the outer wall 115 and the inner annular portion 116.

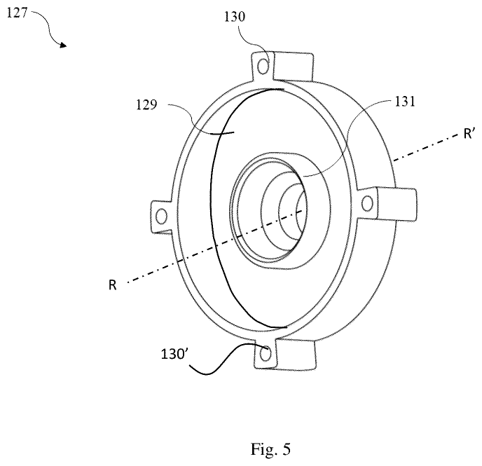

FIG. 5 illustrates a second end cover 127 which covers the outer casing 110 and the stator 111 from an opposite side to that of the first end cover 114 and a second side of the stator 111. The second end cover 127 comprises one or more second locking portions 130 having one or more second end cover locking openings 130′, which enables locking the second end cover 127 with the outer casing 110. The second end cover 127 is provided with a second circular annular projected wall portion 131 in a middle region of the second end cover 127. Also, the second cover 127 comprises an inner annular planer surface 129 adjoining the circular annular portion 131. In an embodiment, the second end cover 127 includes one or more hall sensors for determining the annular position of the one or more teeth 111A of the stator 111.

In an embodiment of the present subject matter, the stator 111 is a stationary electrical component configured to have the one or more teeth 111A on an inner portion of the stator 111. The rotor 113 is located concentrically inside the stator 111 and is mounted to a shaft of the electrical machine 100 along the rotor axis R-R′. The rotor 113 rotates due to magnetic interactions between the stator 111 and the rotor 113. The rotation of the rotor 113 in turns rotates the shaft of the electrical machine 100. In the electrical machine 100 all the electrical components produce heat. However, the stator 111 and the rotor 113 are the main heat producing elements. In order to cool the main heating elements, the present subject matter provides a liquid cooling mechanism which can effectively cool the stator 111 and the rotor 113. As per an embodiment, while air cooling is through the fins, liquid cooling may be controlled through a one or more controller capable of actuating the one or more ports (122, 123).

As per exemplary embodiment of the present subject matter, the first end cover 114 receives coolant from the inlet port 122 which is received by the radially enclosed passage 120′ defined by the base surface 120. One end surface of the base portion 120 is thermally in contact with the teeth 112 of the stator 111. Also, the base surface 120 is configured to prevent any leakage of the coolant from the radially enclosed passage 120′ to the field magnets 112. In such configuration, the base portion 120 acts as a partition wall between the radially enclosed portion 120′ and the field windings 112. The thermal contact between the base portion 120 and the stator 111 ensures that the heat generated from the field windings 112 is effectively conducted to the base portion 120 and such heat is subsequently cooled by the coolant present in the radially enclosed portion 120′. The base portion 120 also ensures that the heat is restricted to the stator 111 and is not transferred to the end of the electrical machine 100. Additionally, the base portion 120 provides a larger surface area for the coolant to act, thereby ensuring complete area being in thermal contact and the base surface 120 is effectively cooled. The coolant is transferred out of the radially enclosed portion through the outlet port 123.

In another embodiment, the base surface 120 is provided with the one or more protruding portions 121 which is also referred as one or more baffles. As per the said configuration, the one or more protruding portions 121 collects the heat from stator 111 which is subsequently effectively cooled by the coolant. The coolant acts more effectively in the one or more protruded portions 121 as the heat is constrained in a designated cross-sectional area which is an increased area due to the baffles. Also, the one or more protruded portions 121 provides effective flow to the coolant. The one or more protruded portions 121 ensure continuous flow of the coolant in the radially enclosed portion and minimize the vortices formation.

In an embodiment, one or more protruded portions 121 are uniformly shaped such that during the continuous flow of the coolant, no vortices formation occurs and the coolant flow is uniform.

In another embodiment, one or more protruded portions 121 are non-uniformly shaped such that minimal vortices formation occurs. In such configuration the flow of the coolant is often not uniform, however, due to continuing movement of the coolant, the cooling efficiency is not compromised.

The electrical machine 100 as per the present invention is cooled by a combination of liquid cooling mechanism and air-cooling mechanism. In such configuration, the outer casing 100 is provided with the one or more fins 128 which ensure continuous air-cooling of the stator 111. Additionally, the liquid cooling is provided through the coolant in the radially enclosed portion 120′ and the base portion 120 which acts as a partition wall between the field windings 112 of the stator 111 and the coolant. In such configuration, the liquid cooling can be enabled or controlled as per requirement. The inlet port 122 and the outlet port 123 can be plugged or sealed in case the electrical machine 100 is to be only air-cooled. However, in case the electrical machine 100 is desired to be cooled through both air-cooling and liquid-cooling, the inlet port 122 and the outlet port 123 can be unplugged.

Although the subject matter has been described in considerable detail with reference to certain embodiments thereof, other embodiments are possible. It is to be understood that the appended claims are not necessarily limited to the features described herein. Rather, the features are disclosed as embodiments of the present subject matter.

LIST OF REFERENCE SIGNS

100: Electrical Machine
110: Outer Casing
111: Stator
111′: Stator cylindrical surface
111A: Stator Teeth
111s: Lateral end surface of stator
112: Field windings
113: Rotor
114: First End Cover
115: Outer Wall
115′: Circumferential annual surface
116: End Cover Inner Annular Portion
118: Radial Surface
119: Locking Portions
119′: Outer wall locking openings
120: Base portion
120′: Enclosed passage
121: Protruded Portions
122: Inlet Port
123: Outlet Port
124: Lid Locking Portions
124′: Lid locking openings
125: Lid Annular wall Portion
125A: Radial Annular Surface
126: Planar base Portion
127: Second End Cover
128: Fins
129: Inner annular Planer Surface
130: Second Locking Portions
130′: Second end cover locking openings
131: Second Circular Annular Wall Portion
132: Lid

1.-12. (canceled)

13. An electrical machine comprising:
a stator;
a rotor, the rotor being electrically coupled to the stator;
a first end cover, the first end cover being in thermally conductive contact with the stator at a first side of the stator; and
a lid attached to the first end cover from one side of the electrical machine for enclosing a coolant within the first end cover, wherein
the first end cover comprises:
an outer wall, the outer wall having one or more ports for receiving the coolant;
an end cover annular portion, the end cover annular portion and the outer wall being spaced at a first predetermined distance ‘a’; and
a base portion, the outer wall and the end cover annular portion being projecting orthogonally to the base portion thereby forming a radially enclosed passage,
the radially enclosed passage being in thermally conductive contact with the stator for transferring heat to the base portion, and
the radially enclosed passage being configured to receive the coolant for extracting heat from the base portion thereby cooling the stator.

14. The electrical machine according to claim 13, wherein
the end cover annular portion having a radial surface and the lid includes a lid annular wall portion, and
the lid annular wall portion abuttingly snug fits the radial surface of the end cover annular portion.

15. The electrical machine according to claim 13, wherein the base portion includes one or more protruded portions.

16. The electrical machine according to claim 15, wherein the one or more protruded portions are uniformly shaped baffles.

17. The electrical machine according to claim 15, wherein the one or more protruded portions are non-uniformly shaped baffles.

18. The electrical machine according to claim 13, wherein the outer wall includes one or more locking portions and the locking portions being configured to attach to an outer casing of the stator.

19. The electrical machine according to claim 13, wherein the one or more ports includes an inlet port and an outlet port.

20. The electrical machine according to claim 13, wherein the lid includes one or more lid locking portions.

21. The electrical machine according to claim 13, wherein
the stator is connected to a second end cover at a second side of the stator, and
the second end cover covers the stator from an opposite side to the first end cover.

22. The electrical machine according to claim 13, wherein the stator is configured to be air cooled through a plurality of fins on an outer casing of the stator.

23. The electrical machine according to claim 13, wherein the stator is configured to have one or more teeth on an internal surface of the stator and the one or more teeth being covered by one or more field windings.

24. The electrical machine according to claim 13, wherein opening and closing of the one or more ports is electronically controlled by one or more controller.
